(19) United States
(12) Patent Application Publication
(10) Pub. No.: US 2008/0048046 A1
(43) Pub. Date: Feb. 28, 2008

(54) Networked appliance information display apparatus and network incorporating same

(75) Inventors: Phillip Ryan Wagner, Baltimore, OH (US); John Gilman Chapman, Delaware, OH (US); Joseph P. Rao, Dublin, OH (US); Nicholas Ashworth, Dublin, OH (US); George Norman Catlin, Grove City, OH (US); Robert Burt, Columbus, OH (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Ranco Inc. of Delaware, Wilmington, DE (US)

(21) Appl. No.: 11/509,281

(22) Filed: Aug. 24, 2006

(51) Int. Cl. B64D 13/00; F24D 19/10; G05D 23/00; F25B 49/00; G01M 1/38

(52) U.S. Cl. 236/91 R; 236/91 D; 236/94; 700/278; 62/126

(57) ABSTRACT

The graphic user interface of an HVAC thermostat displays the programming and status information for remote devices in communication with the thermostat, such as various home sensors and appliances. In an embodiment, the thermostat includes a touch screen display to present the user with a plurality of user interface screens. The monthly calendar interface screen includes a calendar graphic area comprising a matrix display of dates for a full month. The user selects a programming interval for which to enter the thermostat programming events from the calendar graphic area. The user interface includes a clock face interface screen for entry of thermostat programming events. The clock face screen includes a pair of clock face graphic areas for each daily thermostat programming event. The user interface also includes a screen for displaying the programming and status information for remote devices selected from a list of devices in communication with the thermostat.

### CROSS-REFERENCE TO RELATED APPLICATIONS

This patent application is related to a copending U.S. patent application Ser. No. 11/031,087, filed Jan. 6, 2005, which is herein incorporated by reference in its entirety for everything it describes and teaches.

### FIELD OF THE INVENTION

The present invention relates generally to network information management and control, and more particularly to centralized display of information related to networked home appliances and other devices.

### BACKGROUND OF THE INVENTION

With a growing sophistication of consumer electronics, there is an increasing number of home electronic devices capable of programmable operation and status reporting. When it comes to home appliances, an average consumer has come to expect a certain level of intelligence built into each appliance, such as electronic timers, temperature readouts, and battery status displays.

However, traditional home appliances, such as water heaters, pool pumps, and the like, even when capable of communicating the information related to their operation, lack an external user interface display that is easy to read and readily accessible to the user. Adding such a user interface display to many of these appliances is not cost effective. Hence, while some home appliances are able to relay this information to service technicians, most consumers do not have the equipment necessary to retrieve this information from the appliance, and therefore must resort to less effective troubleshooting methods or call the service technician.

Furthermore, many such devices are responsible for running the day-to-day operation of an average home, and therefore have a direct impact on a consumer's energy costs. Logically, therefore, most consumers want to save on energy costs through monitoring of home status and adjusting the programming schedule of the relevant home devices and appliances. However, most home appliances are not networked and monitoring of device status and programming schedules throughout the home requires the consumer to separately interface with each device. Thus, not having a centralized display of the desired home status information, leads to difficulty in coordinating the operation of devices operating in different programming modes.

Finally, while such home appliances as a thermostat, have traditionally been used to relay the status and programming information related to the connected heating, ventilation, and air conditioning (HVAC) equipment, a traditional thermostat user interface is not intuitive to the user.

### BRIEF SUMMARY OF THE INVENTION

The invention provides a local sensor node for monitoring a building and having a centralized display of programming and status information related to the local sensor node, as well as to one or more remote nodes in communication with the local sensor node. The local sensor node includes a user interface for displaying the status and programming information via a plurality of graphic user interface screens. The graphic user interface screens provide for a user-friendly entry of programming events for the local sensor node by presenting a user with a monthly calendar interface for selecting the dates for which to enter the programming events. The graphic user interface additionally includes a clock face for intuitively selecting the time intervals corresponding to each programming event. The user interface further includes screens for selecting one or more nodes from a list of remote nodes in communication with the local node, and displaying the programming and status information related to the selected remote nodes. Additional remote nodes are automatically detected at the local sensor node. Alternatively, the user interface provides for entry of setup information for additional remote nodes based on user input at the local sensor node.

In one embodiment, the system of the present invention leverages the graphic user interface of an HVAC thermostat to display the programming and status information for remote devices in communication with the thermostat, such as various home sensors and appliances. Preferably, the thermostat uses a wireless interface to connect to the remote devices. The remote devices in communication with the thermostat include a plurality of microcontrollers connected, respectively, to a refrigerator, a water heater, and a pool pump. The microcontrollers are capable of receiving control signals from the thermostat, as well as generating remote signals containing programming and status information for the connected devices.

Other remote devices in communication with the thermostat may include a plurality of sensors located in or proximate to the building. In order to collect the relevant sensor data throughout the system, the sensors are strategically located in different zones of the building. The remote sensors transmit signals, which include information on a sensor's operational status, battery status, as well as such sensor information as temperature and humidity of the ambient environment in the vicinity of each sensor. Other embodiments include various other types of remote sensors, such as smoke or carbon monoxide detectors, for example. Hence, the sensor signals will contain sensor data corresponding to the type of sensors employed in the system.

The thermostat further includes a processor, which periodically polls the microcontrollers associated with the refrigerator, the pool pump, and the water heater for status and programming information specific to each connected remote device. Similarly, the processor periodically polls the remote sensors for their status information. In an embodiment, the thermostat includes a touch screen display to present the user with a plurality of graphic user interface screens, which, in turn, include a plurality of interactive display areas used to display and select virtual user input elements, such as buttons, check boxes, or drop down lists specific to each interface screen.

The default thermostat user interface screen includes an ambient temperature display area, as well as virtual buttons for causing the thermostat to enter into a programming mode and to enter an interface screen for viewing the programming and status information for the remote devices.

When the user selects the virtual button for programming the thermostat, the touch screen display shows a monthly calendar interface screen. The monthly calendar interface screen includes a calendar graphic area comprising a matrix display of dates for a full month. The user selects a programming interval for which to enter the thermostat programming events from the calendar graphic area. To indicate the dates with previously entered programming events, icons are disposed adjacent to such dates. This allows a user an at-a-glance determination as to which dates remain to be programmed or which dates contain editable programming events. Other embodiments include highlighting, outlining, or displaying in reverse text the dates with previously entered programming events.

To facilitate the entry of daily thermostat programming events, the user interface includes a clock face interface screen. The clock face screen includes a pair of clock face graphic areas for each daily programming event. Preferably, the clock face graphic areas depict an analog clock face and further include user modifiable clock hand controls. The clock face interface screen further includes a drop down temperature slider control, which allows a user to select the desired temperature set point by simply dragging the slider control up or down the temperature scale until the associated text area displays the desired temperature.

Finally, the user interface includes a screen for displaying the programming and status information for remote devices selected from a list of devices in communication with the thermostat. The user is able to choose between the display of status and/or programming information by selecting the corresponding virtual check boxes.

### BRIEF DESCRIPTION OF THE SEVERAL VIEWS OF THE DRAWING(S)

FIG. 1 is an exploded view of a building showing an exemplary environment for a thermostat in communication with the HVAC equipment, remote temperature/humidity sensors, a level sensor, and a router, which is wirelessly connected to microcontrollers controlling a refrigerator, a water heater, and a pool pump;

FIG. 2 is a perspective view of an exemplary embodiment of the thermostat with a touch screen having a default user interface;

FIG. 3 is a schematic diagram of an internal structure of the thermostat of FIG. 2 showing the electronics responsive to the user input elements;

FIG. 4 illustrates a monthly calendar as part of a graphic user interface for the thermostat of FIG. 2, where the monthly calendar responds to user inputs to program the thermostat and comprises a full-month of programming dates for a current or future month, as well as an iconic representation of previously programmed events;

FIG. 5 illustrates a user selected thermostat programming interval for the monthly calendar of FIG. 4;

FIG. 6 illustrates a partial monthly calendar as part of a graphic user interface for the thermostat of FIG. 2, showing only the dates selected for programming the thermostat and being displayed when more than one date is selected for programming from the monthly calendar of FIGS. 4 and 5;

FIG. 7 illustrates a programming mode selection interface displayed when more than one date is selected for programming from the monthly calendar graphic screen of FIGS. 4 and 5;

FIG. 8 illustrates a daily calendar as part of a graphic user interface for the thermostat of FIG. 2, the daily calendar being displayed when only one date is selected for programming from the monthly calendar interface of FIG. 4;

FIG. 9 illustrates a clock face interface for entering thermostat programming events for a multi-day programming interval selected in FIGS. 5 and 6, where the programming mode selected in FIG. 7 is a single program for all dates, and further illustrating user entry of a first programming event;

FIG. 10 illustrates a clock face interface for entering programming events for a multi-day programming interval selected in FIGS. 5 and 6, where the programming mode selected in FIG. 7 is a single program for all dates, and further illustrating user entry of a second programming event, as well as displaying a first programming event entered in FIG. 9;

FIG. 11 illustrates an interface for entering an all-day programming event for a multi-day programming interval selected in FIGS. 5 and 6, where the programming mode selected in FIG. 7 is a single program for all dates;

FIG. 12 illustrates a clock face interface for entering programming events for a multi-day programming interval selected in FIGS. 5 and 6, where the programming mode selected in FIG. 7 is a separate program for each date;

FIG. 13 illustrates a clock face interface for entering programming events for a single day programming interval selected in FIGS. 4 and 8 and illustrating user entry of a first programming event;

FIG. 14 illustrates a device selection interface as part of a graphic user interface for the thermostat of FIG. 2, the interface allowing user selections of viewing the remote device information either within a specific zone, or viewing all remote devices in communication with the thermostat;

FIG. 15 illustrates an interface for selecting at least one remote device from a list of remote devices within a specific zone, as selected in FIG. 14;

FIG. 16 illustrates an interface for displaying the status information for the remote devices selected in FIG. 15, and iconically representing the type of information displayed;

FIG. 17 illustrates an interface of FIG. 16 but displaying both status and programming information; and

FIG. 18 illustrates an interface for adding additional remote devices through user input and being accessible from the remote device interface of FIGS. 16 and 17.

### DETAILED DESCRIPTION OF THE INVENTION

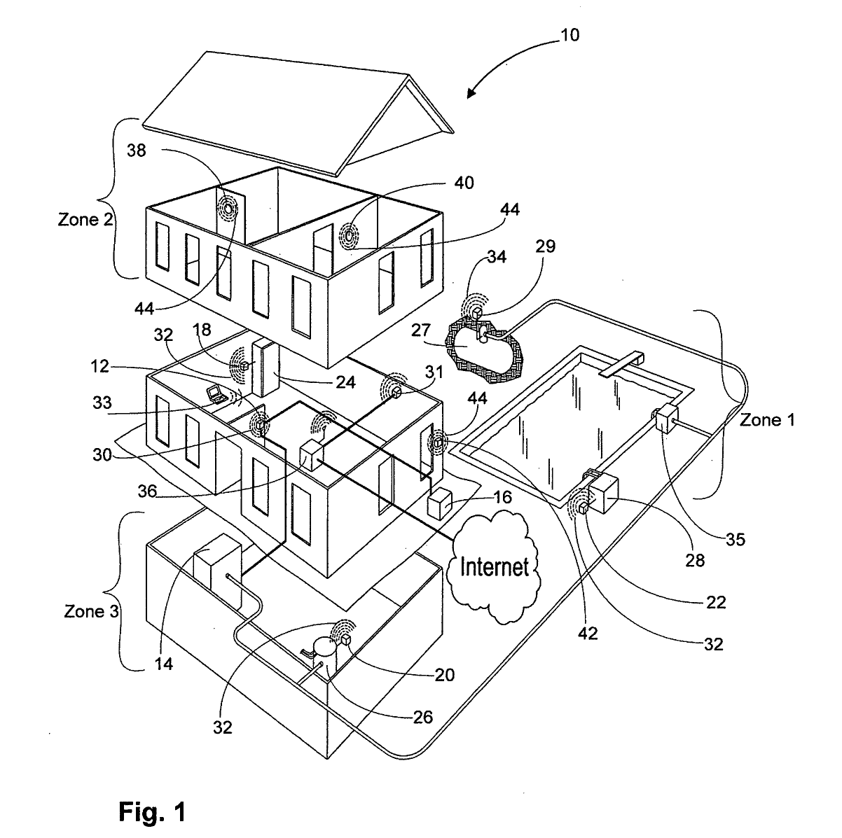

FIG. 1 depicts an exemplary environment of a system according to the present invention showing a network of nodes, with at least one local sensor node monitoring a building 10 while in communication with one or more remote nodes, or devices, located in or proximate to the building 10. The local sensor node, which preferably is a thermostat 12, acts as a hub for sensing and controlling the ambient temperature, as well as for managing the programming and status information related to the thermostat 12 and to the connected devices. Although in FIG. 1 the system of the present invention is depicted in a home environment, one skilled in the art will recognize that the present invention is not limited to a home environment, but may also be installed in other environments, such as in a commercial environment, for example.

In this embodiment, the thermostat 12 connects to the furnace 14 and the air conditioning unit 16 in a conventional manner, while other embodiments include wireless control of the HVAC components. The remote devices in communication with the thermostat 12 include a plurality of microcontrollers 18, 20, 22 connected, respectively, to a refrigerator 24, a water heater 26, and a pool pump 28. The microcontrollers 18, 20, 22 are preferably internal to each remote device 24, 26, 28, although, for clarity, in FIG. 1 the microcontrollers 18, 20, 22 are shown separately from the corresponding remote devices. Alternate embodiments include externally connected microcontrollers 18, 20, 22, such as through a serial port, for example.

The microcontrollers 18, 20, and 22 are capable of receiving control signals 30 from the thermostat 12, as well as generating remote signals 32 containing programming and status information for the connected devices. In an embodiment, the control signals 30 include remote device operational instructions, such as power up/down times or minimum daily run times, for example. Preferably, the microcontrollers 18, 20, 22 and the thermostat 12 communicate wirelessly via signals 30, 32 by using a short-range wireless protocol. For example, in one embodiment, the microcontrollers 18, 20, 22 communicate with the thermostat 12 via a low power wireless protocol based on an IEEE 802.15.4 standard. One such protocol is the Invensys Wireless Protocol that is currently available for licensing. However, it should be understood by those skilled in the art that other embodiments include alternate wireless protocols, such as ZigBee™ or other IEEE 802.15.4 based protocols. Additional embodiments include using a Wi-Fi® protocol, a Bluetooth® protocol, or using wired connections, such as 10 BASE-T or 100 BASE-T Ethernet. A suitable example of a microcontroller 18, 20, 22 is an Invensys Wireless Network Module (WNM), which is compatible with the Invensys Wireless Protocol. Suitable examples of remote devices compatible with the Invensys WNM microcontroller include Invensys model 2000WIPER-LC (160-15-L) water heater control and Invensys model DDL-112771-LXA heat pump control.

The router 36 relays the control signals 30, as well as programming and status signals 32, between the thermostat 12 and microcontrollers 18, 20, 22 and includes a connection to the Internet. In this embodiment, the router 36 is a stand-alone device, however other embodiments include a computer-based router, such as a computer 33 connected to the Internet via cable or DSL modem, for example.

In the illustrated embodiment of FIG. 1, the system also includes a propane tank 27 having a wireless level sensor 29. The propane tank 27 serves as an energy source for the furnace 14, the water heater 26, and the pool heater 35. The wireless level sensor 29 transmits status signals 34, indicating the amount of propane in tank 27, to a level sensor controller 31. The level sensor controller 31, in turn, makes this information available for thermostat 12 via a connection to the router 36. Suitable examples of the wireless level sensor 29 and level sensor controller 31 are, respectively, Robertshaw models GM060EA000JF90G and TC001EAINNF9000.

As further shown in FIG. 1, remote devices in communication with the thermostat 12 may include a plurality of sensors 38, 40, 42 located in or proximate to the building 10. In order to collect the temperature and humidity data throughout the system, the temperature/humidity sensors 38-42 are strategically located in different zones. As shown in FIG. 1, the sensors 38 and 40 are located in different rooms on the same floor, while the sensor 42 is located outdoors and is attached to the exterior wall of the ground floor of the building 10. The remote sensors 38-42 transmit remote status signals 44 to the thermostat 12. In the illustrated embodiment, the remote status signals 44 are transmitted directly from remote sensors 38-42 to the thermostat 12, however in other embodiments, remote status signals 44 are routed between a given remote sensor and the thermostat 12 via the router 36. The remote status signals 44 include information on a sensor's operational status, battery status, as well as such sensor information as temperature and humidity of the ambient environment in the vicinity of each sensor 38, 40, 42. While, in this embodiment, the sensors 38-42 are illustrated as temperature/humidity sensors, other embodiments include various other types of remote sensors, such as smoke or carbon monoxide detectors, for example. Hence, the remote status signals 44 will contain sensor data corresponding to the type of sensors employed in the system.

As with signals 30, 32, preferably, a wireless connection is employed for transmitting the remote sensor status signals 34, 44. In this case, the wireless connection is of the type corresponding to the wireless protocol used with microcontrollers 18, 20, 22, as described above. Other embodiments include using a wired connection, such as a wired 10 BASE-T or 100 BASE-T Ethernet network, in order to communicate the signals 34, 44.

Having described an exemplary operating environment, the following description focuses on the physical description of an embodiment of the thermostat 12 and its operation in the environment, using a graphic user interface (GUI).

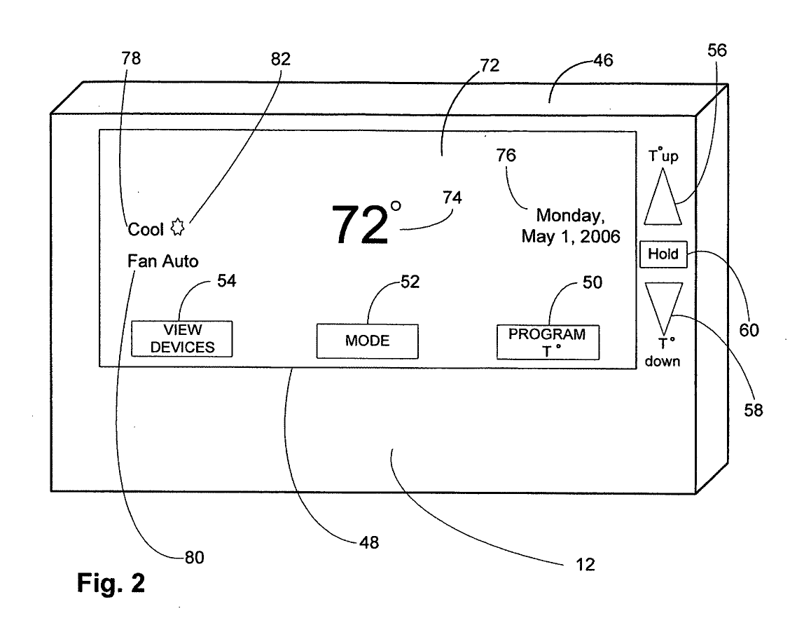

As shown in FIG. 2, in order to achieve a more streamlined appearance of the thermostat 12, the number of hardware buttons within a housing 46 is reduced by including a touch screen display 48. The touch screen display 48 displays a plurality of graphic user interface screens which, in turn, include a plurality of interactive display areas used to display and select virtual user input elements, such as buttons, check boxes, or drop down lists specific to each interface screen. In this embodiment, the user selection of display areas within the touch screen 48 is performed by depressing a corresponding virtual input element, such as the virtual buttons 50, 52, 54 for example. The touch screen display 48 responds to user selection of virtual input elements with a finger, a stylus, or a similar object. The number of hardware user input elements within the housing 46 is therefore reduced to represent only the most frequently used functions, which need to be accessed quickly and without diving into the user interface screens. In the illustrated embodiment, the hardware user input elements of the thermostat 12 include temperature up and temperature down buttons 56, 58 and a temperature hold button 60. Other embodiments include using different types of conventional displays, such as LCD or LED screen displays, as well as using soft buttons selectable from the display by depressing a corresponding hardware button disposed within the housing 46.

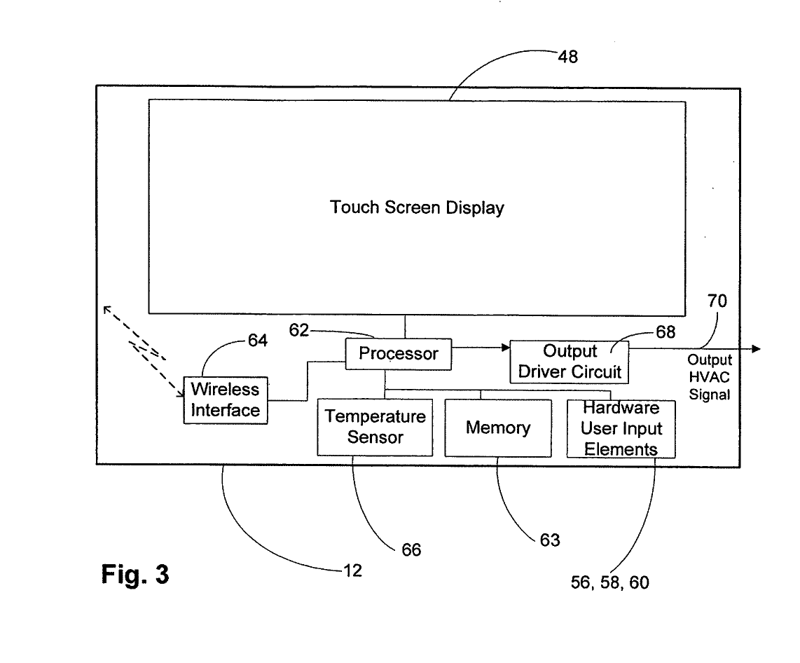

As illustrated in FIG. 3, the thermostat 12 further includes the electronics necessary to process the control signals 30 and remote signals 32, 34, 44 and to select for displaying the status and/or programming information of the connected remote devices. In this embodiment, the electronics include a processor 62, which periodically polls the microcontrollers 18, 20, 22 associated with the refrigerator 24, the pool pump 28, and the water heater 26 for status and programming information specific to each connected remote device. Preferably, the processor 62 sends such information requests through a wireless interface 64. The wireless interface 64 employs any of the short-range wireless protocols known in the art, including those discussed in connection with FIG. 1 above. In one embodiment, the wireless interface 64 is compatible with the Invensys Wireless Protocol, such as by including the Invensys Wireless Network Module, for example. The requested programming and status information is communicated by the microcontrollers 18-22 back to the thermostat 12 via remote signals 32. Remote signals 32 include operational status information, operational failure logs, whether a device has been programmed to operate in a low-power or vacation mode, and set-back parameters. Similarly, the processor 62 periodically polls the remote humidity/temperature sensors 38-42 for their status information, which is relayed back to the thermostat 12 via remote status signals 44. A suitable example of the processor 62 is model ATMEGA 16 manufactured by Atmel.

After receiving the remote signals 32, 44, containing the programming and/or status information from the polled remote devices, the processor 62 decodes the remote signals 32, 44 and stores the associated programming and/or status information in memory 63 for subsequent display through the thermostat's 12 graphic user interface.

The processor 62 is furthermore responsive to the temperature sensor 66 to direct the output circuit 68 to generate an output HVAC signal 70. The output HVAC signal 70 controls the connected HVAC equipment 14, 16 (FIG. 1) in a conventional manner.

Referring again to FIG. 2, when the thermostat 12 is in an idle mode, that is when there is no user interaction with the touch screen display 48 or hard buttons 56-60, a default user interface screen 72 is displayed. The default user interface screen 72 includes an ambient temperature display area 74, a current day/date display area 76, as well as thermostat mode and fan mode display areas 78, 80. In the illustrated embodiment, a thermostat mode icon 82 is displayed next to the thermostat mode display area 78. The default user interface screen 72 further includes a virtual button 50, labeled “PROGRAM T°,” for causing the thermostat 12 to enter into a programming mode of operation. Additional virtual buttons 52, 54, labeled “MODE” and “VIEW DEVICES” respectively, allow a user to change the thermostat and fan modes and to enter an interface screen for viewing the programming and status information for the remote devices.

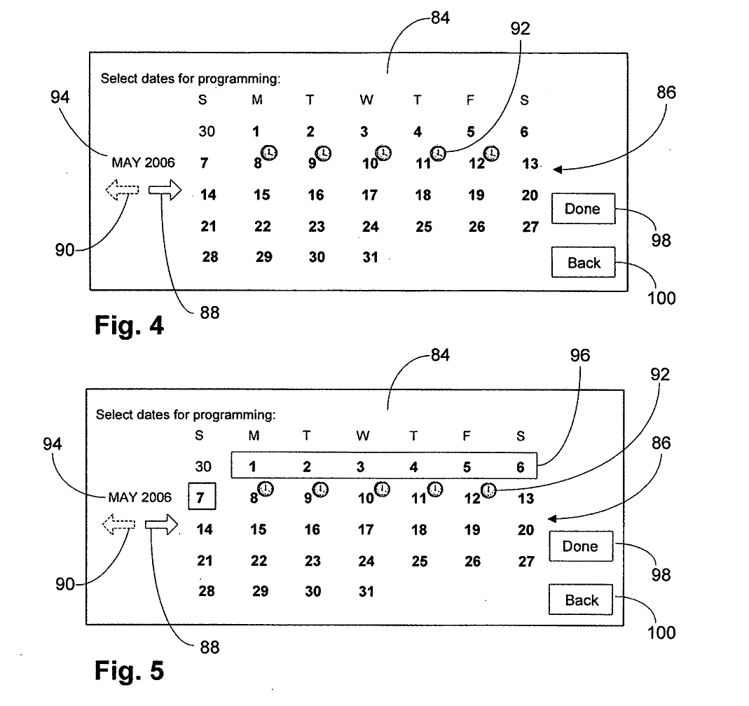

As illustrated in FIG. 4, when “PROGRAM T°” function is selected by depressing the virtual button 50, the touch screen display 48 displays a monthly calendar interface screen 84. The monthly calendar screen 84 includes a calendar graphic 86 comprising a matrix display of dates for a full month. Upon user selection of the virtual button 50, the calendar graphic 86 initially defaults to displaying the dates for the current month. When the calendar graphic 86 includes a few dates from a prior month, such dates will be grayed out in order to indicate that entry of programming events for past dates is not possible. If a user desires to enter programming events for a future month, virtual button 88 is used to scroll the date matrix forward one month at a time. The virtual button 90, in turn, allows the user to scroll the date matrix back one month at a time, up to the current month.

To indicate the dates with previously entered programming events, icons 92 are disposed adjacent to such dates. This allows a user an at-a-glance determination as to which dates remain to be programmed or which dates contain editable programming events. Other embodiments include highlighting, outlining, or displaying in reverse text the dates with previously entered programming events. The text area 94 indicates the month and year of a currently displayed calendar graphic 86.

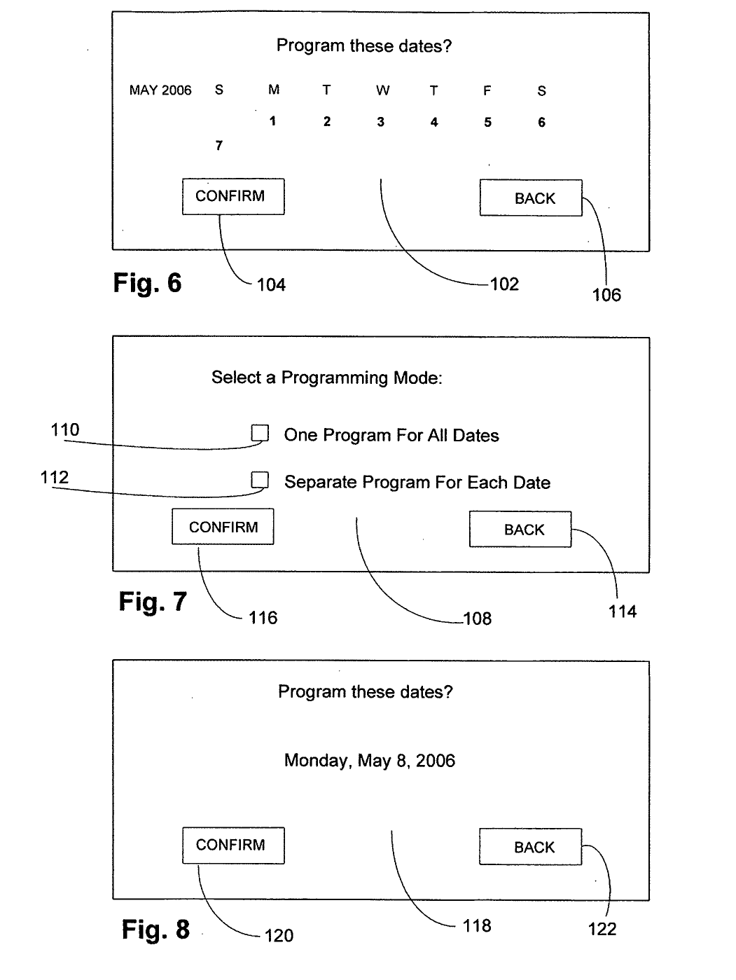

As illustrated in FIG. 5, a user selects a programming interval for which to enter the thermostat programming events on the calendar graphic 86. The selection of a programming interval 96 is done by depressing the stylus or a finger over the desired date or range of dates. Once a user selects the desired programming interval, selection of a virtual button 98, labeled “DONE,” will result in the display of a programming interval confirmation screen 102 (FIG. 6) or 118 (FIG. 8), displayed for multi-day and single-day programming intervals respectively. Alternatively, a user may depress the virtual button 100, labeled “BACK,” in order to bring the display back to the default GUI screen 72 of FIG. 2.

As depicted in FIG. 6, when more than one date is selected as a thermostat programming interval in the monthly calendar interface screen 84 (FIG. 5), a partial monthly calendar interface screen 102 is shown, where only the dates selected for programming are displayed for user confirmation. If a user confirms the desired multi-day range, by selecting the “CONFIRM” virtual button 104, a multi-day programming mode selection screen 108 is displayed, as illustrated in FIG. 7. User selection of the virtual button 106, labeled “BACK,” will change the display to monthly calendar screen 84 (FIG. 4).

In the multi-day programming mode selection screen 108 of FIG. 7, a user is given a choice as to whether to create one thermostat program schedule for all selected dates, or to create a separate program for each date within the selected date range. These choices are made by depressing the appropriate virtual check box 110 or 112 and depressing the “CONFIRM” virtual button 116. User selection of the virtual button 114, labeled “BACK,” will change the display to a previous screen 102.

Alternatively, when only one date is selected from the monthly calendar screen 84, the daily calendar confirmation screen 118 is displayed, as illustrated in FIG. 8. The daily calendar confirmation screen 118 prompts the user to confirm the selected date for which thermostat programming events will be entered by selecting the “CONFIRM’ virtual button 120. As in FIG. 6, user selection of the virtual button 122, labeled “BACK,” will revert the display to the monthly calendar screen 84 (FIG. 4).

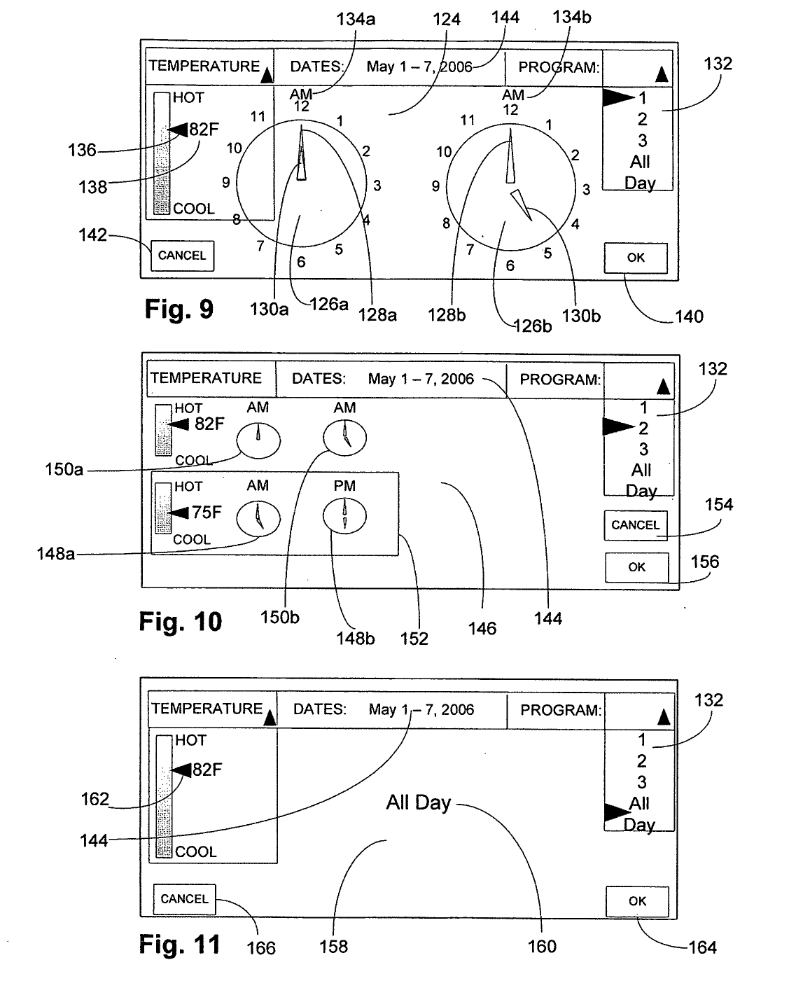

To enter the thermostat programming events for a multi-day programming interval, a user will be presented with interface screens of FIGS. 9-12, while FIG. 13 represents an interface screen for entering the thermostat programming events for a single day programming interval.

Referring to FIG. 9, a clock face interface screen 124 is displayed when a user selects a multiple day programming interval from the monthly calendar screen 84 (FIGS. 4, 5) and chooses to enter one program for all dates in the multi-day programming mode selection screen 108 (FIG. 7). The clock face interface screen 124 facilitates user entry of daily programming events by including a pair of clock face graphic areas 126a, 126b for each daily programming event. Preferably, the clock face graphic areas 126a, 126b depict an analog clock face and further include user modifiable clock hand controls 128a, 128b and 130a, 130b. The clock hand controls 128a, 128b and 130a, 130b become active, that is available for user interaction, upon user selection of the next available programming event from the daily programming event dropdown list 132.

In the illustrated embodiment of FIG. 9, a user is able to enter up to three separate daily programming events to schedule different daily temperature set points. Alternatively, a user is able to select an “All Day” programming event from the dropdown list 132 and create a single daily temperature set point, as discussed in more detail below in connection with FIG. 11. In this embodiment, the programming event numbers in the dropdown list 132 are activated in sequence, while the prior and out-of-sequence event numbers are grayed out and are not available for user selection. Other embodiments include varying the number of programming events within the drop down list 132, such as using a dynamically generated programming event list, for example.

Therefore, upon selection of an available programming event number from the list 132, a user is able to select a time interval during which the thermostat 12 must maintain a desired temperature set point. The time interval is selected by dragging the clock hand controls 128a, 128b and 130a, 130b to the desired start and stop times on the clock face graphic areas 126a, 126b. The user drags the clock hand controls 128a, 128b, 130a, 130b by touching each desired clock hand control 128a, 128b, 130a, or 130b with either a finger or a stylus and moving the clock hand control to the desired position while maintaining contact with the touch screen display 48. In the illustrated embodiment, a user is able to schedule any discrete time interval because the minute controls 128a, 128b are continuously adjustable. In other embodiments, a user is able to adjust the minute controls 128a, 128b in predetermined time intervals, such as in five-minute steps, for example. To complete the entry of a given time interval, a user is able to toggle an “AM”/“PM” designator associated with each clock face graphic area 126a, 126b by tapping on display areas 134a, 134b.

The clock face interface screen 124 further includes a drop down temperature slider control 136 which allows a user to select the desired temperature set point by simply dragging the slider control 136 up or down the temperature scale until the associated text area 138 displays the desired temperature. In this embodiment, once a user sets a desired temperature set point for the first programming event, selection of the “OK” virtual button 140 will commit these changes to memory and activate the second programming event within the drop down list 132. If a user elects to cancel the first programming event, selection of the “CANCEL” virtual button 142 will bring a user back to the monthly calendar interface screen 84 (FIG. 4). In other embodiments, user selection of virtual button 142 may bring the user back to a previous screen 108 (FIG. 7). Furthermore, other embodiments of the clock face interface screen 124 include having the temperature slider control 136 as a pop-up control or a collapsible control.

FIG. 10 depicts the entry of a second programming event for the multi-day programming interval 144. After user entry of the first programming event and selection of the “OK” virtual button 140, the clock face interface screen 146 is formatted to display a reduced size clock face graphic 148a, 148b, representing the current programming event, along with a reduced size clock face graphic 150a, 150b, representing the previously entered programming event for the same programming interval. In the illustrated embodiment, only the clock face graphic 148a, 148b for the current programming event is activated for user manipulation, as indicated by an active area indicator 152. In order to edit a previously entered programming event, a user needs to select the “CANCEL” virtual button 154 to go back to the previous clock face screen 124 (FIG. 9). However, to commit the current changes to memory and advance to the next available programming event, a user needs to select the “OK” virtual button 156. If the temperature set point intervals scheduled by the user equate to a full twenty four hour period, selection of a corresponding “OK” virtual button will revert the touch screen display 48 to the default user interface screen 72 (FIG. 2). Time intervals that are not explicitly assigned temperature set points by the user remain in a default state, such as by using the EnergyStar settings, or remaining at the last user-programmed temperature set point.

While in the clock face interface screens 124, 146 (FIGS. 9, 10), a user has an option of entering a single temperature set point to be maintained throughout the day, rather than scheduling multiple daily temperature set points and programming events. As illustrated in FIG. 11, the interface screen 158 for entering an all-day programming event is displayed upon user selection of the “All Day” programming event choice from the list 132. In the illustrated embodiment, the “All Day” programming event choice remains activated in the drop down list 132 irrespective of whether separate programming event numbers have been previously chosen. Once a user selects an “All Day” programming event from the drop down list 132, the clock face graphic is replaced by an “All Day” text area 160 of interface screen 158. Selection of an “All Day” programming event will also override any prior programming events for the same programming interval. A user is able to enter an all-day temperature set point by selecting and dragging a dropdown temperature slider control 162. Once a user sets the desired temperature set point, selection of the virtual button 164, labeled “OK,” will revert the graphic user interface display to the default graphic user interface screen 72 of FIG. 2. If, however, a user selects the “CANCEL” virtual button 166, the user interface display reverts back to the monthly calendar screen 84 (FIG. 4) to allow selection of an alternate programming interval.

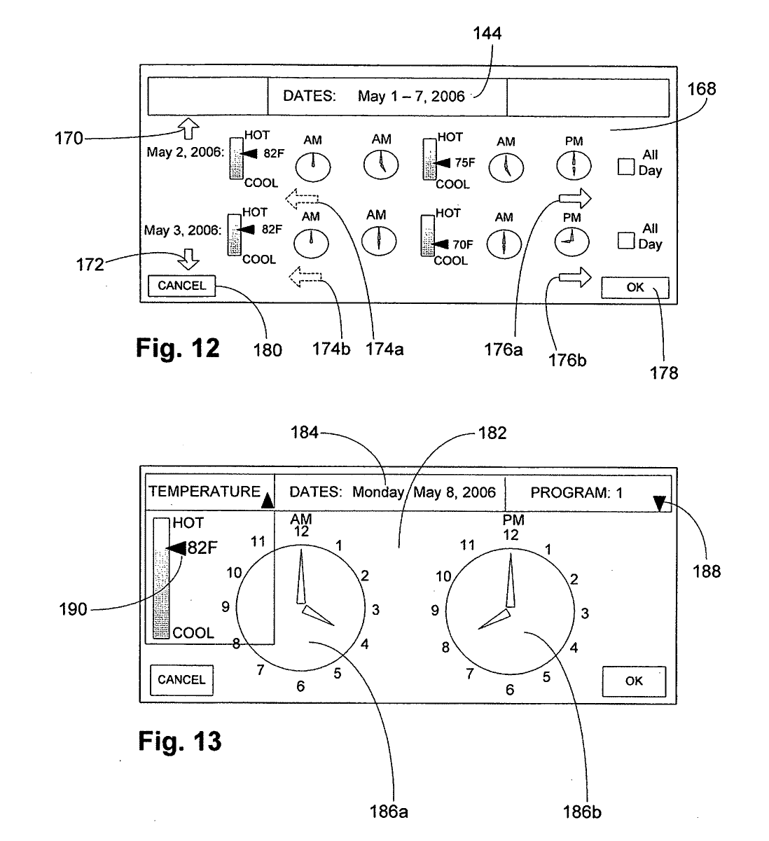

Referring again to FIG. 7, the interface screens 124 (FIG. 9), 146 (FIG. 10), or 158 (FIG. 11) are displayed when a user selects the checkbox 110 to enter one program for all dates within the multi-day interval 144. If, however a user desires to provide a separate temperature program for each date within the interval 144, selection of checkbox 112 causes the graphic user interface to display the clock face interface screen 168, as illustrated in FIG. 12. The clock face interface screen 168 is configured to simultaneously display multiple clock face graphic areas for a plurality of dates within the programming interval 144. The amount of detail displayed on the clock face interface screen 168 depends on the size and resolution of the touch screen display 48 and, in the illustrated embodiment, is restricted to displaying programming events for two days at a time. Additional dates within the selected interval 144 may be displayed by using the virtual up/down scroll buttons 170, 172. Similarly, a user is able to scroll through a plurality of programming events within each date by using virtual left/right scroll buttons 174a, 174b, 176a, 176b associated with each date within a multi-day interval 144. A user is therefore able to simultaneously display and adjust multiple and distinct programming events for each date within the multiple day programming interval 144. Once the programming is complete, a user may return to the default interface screen 72 (FIG. 2) by selecting the virtual “OK” button 178. User selection of the virtual “CANCEL” button 180, on the other hand, will revert the display to the monthly calendar interface screen 84 (FIG. 4) to allow the selection of an alternate programming interval. In other embodiments, user selection of virtual button 180 may bring the user back to a previous screen 108 (FIG. 7).

As indicated in FIG. 13, when a user confirms a single day programming interval from the daily calendar confirmation screen 118 (FIG. 8), a clock face interface screen 182 is displayed. The clock face interface screen 182 facilitates user entry of daily programming events for a single day programming interval 184 and provides the same elements as those described in connection with FIGS. 9, 10, and 11 by including a pair of clock face graphic areas 186a, 186b for each daily programming event, a drop down list 188 with programming event number choices and an “All Day” programming event choice, and a drop down temperature slider control 190. As in FIGS. 9-11, once a user is finished entering programming events for the single day interval 184, the display will revert to the default user interface screen 72 (FIG. 2).

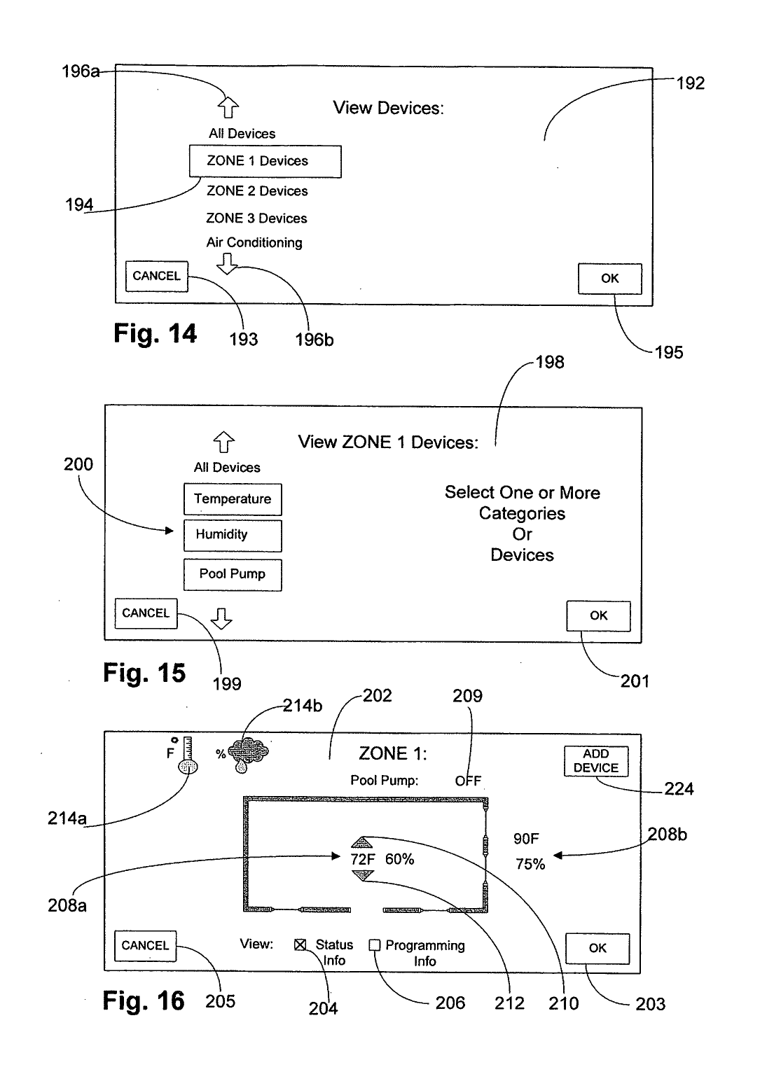

From the default user interface screen 72 (FIG. 2), a user is able to select a “VIEW DEVICES” virtual button 54 in order to view the programming and status information for the connected remote devices. Specifically, user selection of the virtual button 54 will change the display to the device selection user interface screen 192, as illustrated in FIG. 14. While in the device selection screen 192, a user is presented with a list 194 of remote devices located in or proximate to the building 10 and in communication with the thermostat 12. The user is further able to select one or more such remote devices for subsequent display of associated status and/or programming information. The remote device list 194 includes selections to view all devices within the system, only the devices within a predetermined zone, or specific devices irrespective of their location. Virtual scroll buttons 196a, 196b allow the user to scroll through the list 194.

In the illustrated embodiment of FIG. 15, the user is presented with a zone-specific device selection interface screen 198 when the user selects to view the remote device information within a predetermined zone, such as by selecting “ZONE 1 Devices” from the screen 192 (FIG. 14). The zone-specific device selection screen 198 includes a device list 200 comprised of remote devices within the selected zone. The device list 200 includes selections to view the information regarding all devices within the zone, specific types of devices within the zone, or discrete devices located within the selected zone. For example, when the user selects to view the information associated with the pool pump 28, as well as the “Temperature” and “Humidity” devices within Zone 1 of the building 10 (FIG. 1), the status and programming user interface screen 202 is displayed, as shown in FIG. 16.

To display the status and programming interface screen 202, the processor 62 (FIG. 3) reads the information regarding the operating conditions of the selected devices from memory 63 (FIG. 3) if the information has already been received and stored during prior synchronization, or polling events. If, however, this information has not yet been stored in the memory 63, the processor 62 initiates a new synchronization by polling the connected remote devices for associated programming and/or status information.

Referring to FIGS. 1 and 16, the interface screen 202 displays status information for the remote devices selected from the list 200 (FIG. 14). In the illustrated embodiment, “Zone 1” devices include the outside temperature/humidity sensor 42, the refrigerator 24 connected to microcontroller 18, the air conditioning unit 16, the thermostat 12, the pool pump 28 connected to microcontroller 22, the pool heater 35, and the propane tank 27 connected to the wireless level sensor 29. As further illustrated in FIG. 16, the user is able to choose between the display of status and/or programming information by selecting the virtual check boxes 204, 206. Assuming that the user selected the check box 204 in order to view the status information of the devices selected from the list 200, the programming and status interface screen 202 will display the temperature and humidity readings 208a, 208b, associated with the thermostat 12 and the outside temperature/humidity sensor 42, as well as the operational status 209 of the pool pump 28. In the illustrated embodiment, the user is also able to control the temperature within the local environment of the thermostat 12 by using the temperature up/down controls 210, 212. The information legend icons 214a, 214b relate to the user the type of information being displayed, which in the illustrated embodiment is the temperature and humidity information.

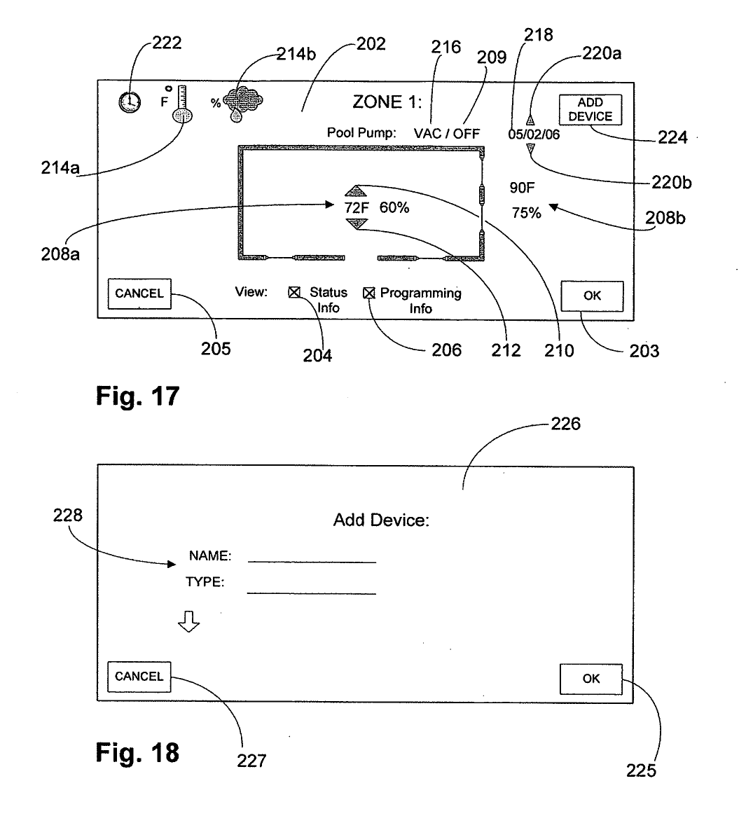

As shown in FIG. 17, if the user chooses to add the display of programming information associated with the selected devices by selecting the virtual check box 206, the interface screen 202 will also display the previously programmed operating mode 216 of the pool pump 28 for the date 218. The user is able to scroll through the previously programmed operating modes 216 for different dates via virtual scroll buttons 220a, 220b. As seen in FIG. 17, the programming mode of pool pump 28 for the date 218 is “VACATION MODE,” which results in the pump's operational status 209 indicating that the pump 28 is “OFF” for this date. The icon 222 represents to the user that programming information is being displayed for one or more of the selected remote devices.

Preferably, the thermostat 12 automatically discovers new remote devices that are added to the system when it periodically seeks out new devices within the range of the wireless interface 64 (FIG. 3). In this case, the thermostat 12 automatically compiles a list of devices and makes their programming and/or status information immediately available. In one embodiment, this is accomplished via the Invensys Wireless Protocol. When alternate connection protocols are employed for interconnection of the thermostat 12 and corresponding remote devices or sensors, the thermostat 12 automatically discovers new devices via Universal Plug and Play (UpNp) or DLNA specifications. In spite of being automatically detected, parameters such as device names remain editable by the user.

In another embodiment, to manually compile a list of remote devices, the interface screen 202 includes an “ADD DEVICE” virtual button 224. As shown in FIG. 18, upon user selection of the virtual button 224, a user is able to input additional devices and corresponding device characteristics via remote device input screen 226. The remote device input screen 226 includes user-editable fields 228 for accepting the characteristics of a new remote device. In one embodiment, a virtual on-screen keyboard (not shown) is used to input the description of the newly added remote device. Other embodiments may include adding remote devices by uploading remote device characteristics through a computer input at the thermostat 12, such as a USB input (not shown), a serial input, or the like.

It should be further noted that in FIGS. 14-18 above, the virtual “OK” buttons 195, 201, 203, 225 and virtual “CANCEL” buttons 193, 199, 205, 227 operate in a manner similar to those described in connection with FIGS. 9-13. Finally, those of ordinary skill in the art will appreciate that the virtual button text of FIGS. 2-18 is exemplary only and other embodiments include alternate button labels.

While a preferred embodiment of the present invention utilizes the thermostat to coordinate system operation as discussed above, other embodiments of the system of the present invention utilize a separate central control point to coordinate operation of the system. That is, this central control point need not be a thermostat. The central control point could be a separate controller having a user interface whose functionality is limited to coordination of and communication with the components in the system. This separate controller may be a stand-alone controller or a PC application, for example. Additionally, in embodiments of the present invention in which a thermostat provides this central control point, the user interface and the control portions of such a thermostat need not be integrated into a single housing. That is, the user interface may be mounted in a commonly user accessed area for convenience, while the control electronics could be located remotely from the user interface.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A thermostat for controlling an HVAC system in a building and communicating with one or more remote devices, the thermostat comprising:
a housing;
a sensor for generating a local temperature signal of an ambient environment;
a user interface for displaying the local temperature, a list of one or more remote devices, and a calendar for programming the thermostat; and
electronics responsive to user inputs for controlling the local temperature and selecting for display one or more operating conditions of at least one remote device selected from the list.

2. The thermostat of claim 1 wherein the user interface includes a clock face for entering at least one programming event for at least one date selected from the calendar.

3. The thermostat of claim 1 wherein the at least one remote device is selected from one of:
a list of discrete devices in or proximate to the building;
a list of discrete devices within a one or more predetermined zones in or proximate to the building; and
all devices within the one or more predetermined zones in or proximate to the building.

4. The thermostat of claim 1 wherein the operating conditions of the at least one remote device include remote sensor information.

5. The thermostat of claim 1 wherein the operating conditions of the at least one remote devices include operational status information.

6. The thermostat of claim 1 wherein the operating conditions of the at least one remote device include programming information.

7. The thermostat of claim 2 wherein the user interface is configured to format the clock face based on one of a thermostat programming interval and a number of selected thermostat programming events.

8. The thermostat of claim 1 wherein the user interface includes iconic representation of thermostat programming events.

9. The thermostat of claim 1 wherein the calendar allows selection of a thermostat programming interval and displays one or more dates based on the selected programming interval.

10. A network of nodes monitoring a building, the network comprising a local sensor node and one or more remote nodes, wherein the local sensor node comprises a display of (1) status and programming information about conditions directly controlled by the local sensor node, and conditions directly controlled by at least one of the one or more remote nodes, and (2) a monthly calendar interface for programming the local sensor node.

11. The network of claim 10 wherein the local sensor node comprises a thermostat that polls the one or more remote nodes for the status and programming information.

12. The network of claim 10 wherein the local sensor node comprises a thermostat that receives and stores the status and programming information from the one or more remote nodes.

13. The network of claim 10 wherein the local sensor node automatically detects an addition of a wireless remote node to the network.

14. The network of claim 10 wherein the status information includes at least one of remote sensor information and operational status information.

15. The network of claim 10 wherein the programming information includes at least one of setback schedule information and vacation schedule information.

16. A method for centrally displaying information from two or more devices associated with a building, where one of the devices includes a HVAC thermostat in communication with at least one remote device, the method comprising:
displaying at a user interface programming and status information for the at least one remote device selected from a list of remote devices in communication with the thermostat;
displaying at the user interface a calendar and clock responsive to user inputs for entering thermostat programming events.

17. The method of claim 16 wherein the step of displaying the programming and status information for the at least one remote device comprises polling the at least one remote device for the programming and status information.

18. The method of claim 16 wherein the step of displaying the programming and status information for the at least one remote device comprises receiving and storing the programming and status information from the at least one remote device.

19. The method of claim 16 including automatically detecting an addition of a wireless remote device associated with the building.

20. The method of claim 16 further comprising selecting one of predetermined time intervals and discrete times from the clock for entering the thermostat programming events.
